(19) United States
(12) Patent Application Publication
(10) Pub. No.: US 2018/0039787 A1
(43) Pub. Date: Feb. 8, 2018

(54) INFORMATION PROCESSING APPARATUS, APPLICATION MANAGEMENT METHOD, AND IMAGE FORMING APPARATUS

(71) Applicant: CANON KABUSHIKI KAISHA, Tokyo (JP)

(72) Inventor: Satoki Watariuchi, Tokyo (JP)

(21) Appl. No.: 15/646,449

(22) Filed: Jul. 11, 2017

(30) Foreign Application Priority Data
Aug. 2, 2016 (JP) 2016-152292

(51) Int. Cl. G06F 21/62; H04L 29/06; G06F 21/60

(52) U.S. Cl. CPC G06F 21/6209; G06F 21/602; H04L 63/10; H04L 63/062; G06F 2221/0753; G06F 2221/0768; G06Q 2220/18

(57) ABSTRACT

A device application including the URL of a web application is prepared as an application to be installed in an image processing apparatus. Upon the device application being called, the URL of the web application included in that application is set and displayed in a web browser. A license can be managed for the web application too as a result.

### BACKGROUND OF THE INVENTION

### Field of the Invention

The present invention relates to an information processing apparatus, an application management method, and an image forming apparatus.

### Description of the Related Art

Systems that can expand the functions of a multifunction peripheral (MFP) having a scanning function, a printing function, and so on by installing applications in the multifunction peripheral are recently becoming widespread. A system for managing application licenses on a multifunction peripheral-by-multifunction peripheral basis is also known (see Japanese Patent Laid-Open No. 2006-40217, for example).

Furthermore, a technique is known in which an operating screen of a web application provided from a web server connected to a network is displayed in a web browser provided in a multifunction peripheral, and a user makes operations through that operating screen.

However, thus far, there have been no systems for a web application to manage licenses on a multifunction peripheral-by-multifunction peripheral basis. Even if a web application is to manage licenses on a multifunction peripheral-by-multifunction peripheral basis, the web application is not an application installed in the multifunction peripherals. There has thus been a problem in that the existing application license management system cannot be used as-is. Furthermore, in the case where a dedicated web application system is prepared in addition to the existing license management system, multiple different license management systems will ultimately be prepared for a single multifunction peripheral. This is problematic in that it is less convenient for sellers and administrators.

### SUMMARY OF THE INVENTION

The present invention provides an information processing apparatus and an application management method capable of realizing web application license management in the same manner as for applications installed in the information processing apparatus.

The present invention has the following configuration. That is, according to a first aspect of the present invention, there is provided an information processing apparatus comprising: a platform for executing an installed application program; and a license management unit that determines whether a license of the installed application program is valid and permits the application program to be executed if the license is determined to be valid, wherein in response to a call instruction, the license management unit determines whether or not a license of a first application program is valid, and permits the first application program to be executed if the license is determined to be valid, wherein the first application program is installed with the license, uniquely associated with access destination information for calling a specific web application, and accesses an access destination specified in the access destination information.

According to another aspect of the present invention, there is provided an information processing apparatus, in which is installed a device application associated with an access destination for receiving a service from a specific web application, that manages a license of the web application by managing a license of the device application.

According to yet another aspect of the present invention, there is provided an image forming apparatus comprising: a web browser; and an installing unit that, in the case where a license in license information of an application is determined to be valid using the license information, installs the application, wherein a first application that realizes a function in the image forming apparatus and a second application that realizes a function of a web app in a web server by calling the web browser are installed using the installing unit.

The present invention provides an effect that web application license management can be realized in the same manner as for applications installed in the information processing apparatus.

Further features of the present invention will become apparent from the following description of exemplary embodiments (with reference to the attached drawings).

### BRIEF DESCRIPTION OF THE DRAWINGS

FIG. 1 is a diagram illustrating the overall configuration of an information processing system according to an embodiment of the present invention.

FIG. 2 is a block diagram illustrating the hardware configuration of an MFP according to the embodiment.

FIG. 3 is a block diagram illustrating the hardware configuration of a license management server according to the embodiment.

FIG. 4 is a block diagram illustrating the software module configuration of the license management server according to the embodiment.

FIG. 5A is a diagram illustrating an example of an MFP app management table according to the embodiment.

FIG. 5B is a diagram illustrating an example of a license management table.

FIG. 6 is a diagram illustrating an example of a license file issued by the license management server according to the embodiment.

FIG. 7 is a diagram illustrating an application and the software module configuration of the MFP according to the embodiment.

FIG. 8 is a diagram illustrating the software module configuration of a web connection MFP app according to the embodiment.

FIG. 9 is a diagram illustrating an example of a manifest file of the web connection MFP app according to the embodiment.

FIG. 10 is a diagram illustrating the software module configuration of a web app server according to the embodiment.

FIG. 11 is a flowchart illustrating an example of processing performed by the MFP according to the embodiment.

FIG. 12 is a diagram illustrating an example of a GUI displayed in a console unit of the MFP according to the embodiment.

FIG. 13 is a sequence chart illustrating an example of processing performed by the information processing system according to the embodiment of the present invention.

FIG. 14 is a flowchart illustrating an example of processing performed by the MFP according to the embodiment.

FIG. 15 is a flowchart illustrating an example of processing performed by the web app server according to the embodiment.

FIG. 16 is a diagram illustrating the software module configuration of a local MFP app according to the embodiment.

FIG. 17 is a diagram illustrating an example of a manifest file of the local MFP app according to the embodiment.

FIG. 18 is a diagram illustrating an example of a license information table according to the embodiment.

FIG. 19 is a flowchart illustrating an example of processing performed by the MFP according to the embodiment.

FIG. 20 is a flowchart illustrating an example of processing performed by the MFP according to the embodiment.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

In the present embodiment, “application” is defined as follows. An application of a type provided from a web server connected to a network is called a “web application” (or a “web app”). An operating screen of a web app is displayed using a web browser provided in a multifunction peripheral. Meanwhile, an application of a type installed in a multifunction peripheral is called an “MFP application” (or “device application”; “MFP app” hereinafter). An installed MFP app is stored as data and a program in the multifunction peripheral.

Information Processing System

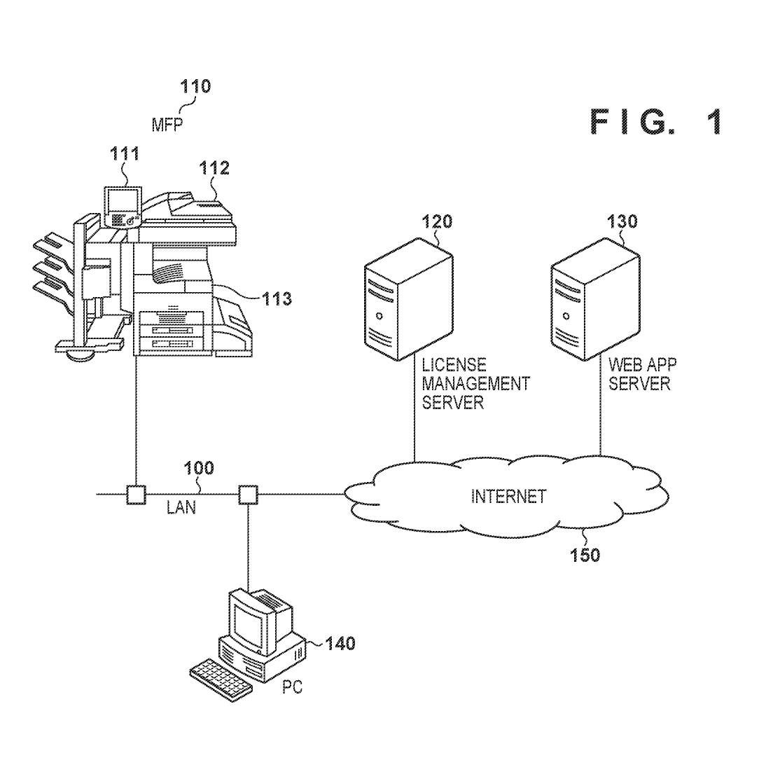

FIG. 1 is a diagram illustrating the overall configuration of an information processing system according to an embodiment of the present invention. In this information processing system, an MFP 110 and a PC 140 are connected over a LAN 100, and the LAN 100 is connected to the Internet 150. Furthermore, a license management server 120 and a web app server (web server) 130 are connected to the Internet 150.

The MFP 110 is a multifunction peripheral including a console unit 111, a scanner unit 112, and a printer unit 113. The MFP 110 according to the embodiment functions as a client terminal that uses an included (in other words, installed) web browser to display and operate operating screens of web apps. Additionally, the MFP 110 can print an image obtained from the web app using the printer unit 113 in response to an instruction from the web app, and can read a document using the scanner unit 112 and send image data obtained as a result to the web app. Accordingly, the MFP 110 has a service provider that provides functions such as the printer, the scanner, and so on of the device (that is, the MFP) to the web app. As a result, a web app accessed from the MFP 110 can request the service provider of the MFP 110 to provide a service using a desired function. Note that an identifier called a “device ID” is assigned to the MFP in this embodiment, and each MFP can be identified and recognized uniquely using this identifier.

The license management server 120 is a server that manages a license of the MFP app. The web app server 130 is a server that executes a web app. The PC 140 functions as a terminal apparatus for making various types of settings in the MFP 110. Note that the system configuration described thus far is merely one example, and the numbers and so on of these devices are not limited to those described in the present embodiment.

Hardware of Image Forming Apparatus (MFP)

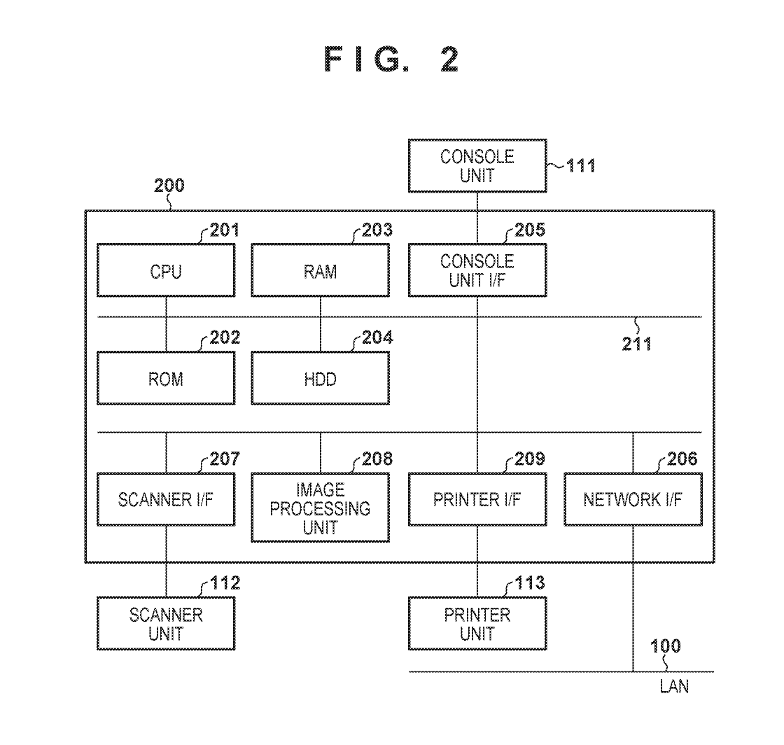

FIG. 2 is a block diagram illustrating the hardware configuration of the MFP 110 according to the embodiment. The console unit 111 includes a display unit having touch panel functionality, various types of physical keys, and so on, displays information to a user in accordance with data from a control unit 200, and inputs information to the control unit 200 in response to user operations. The scanner unit 112 reads an image of a document, generates image data of that image, and supplies the image data to the control unit 200. The printer unit 113 prints an image based on the image data received from the control unit 200 onto paper.

The control unit 200 is electrically connected to the console unit 111, the scanner unit 112, and the printer unit 113, and is also connected to the LAN 100 via a network interface (I/F) 206. This enables communication using a communication protocol such as TCP/IP over the LAN 100. In the control unit 200, a CPU 201, ROM 202, RAM 203, an HDD 204, a console unit I/F 205, the network I/F 206, a scanner I/F 207, an image processing unit 208, and a printer I/F 209 are connected via a system bus 211. The CPU 201 executes a boot program in the ROM 202, loads an OS, control programs, and so on stored in the HDD 204 into the RAM 203, and controls the MFP 110 as a whole on the basis of those programs. This control also includes the execution of programs for realizing the flowcharts mentioned later. The boot program of the MFP 110, various types of data, and so on are held in the ROM 202. The RAM 203 provides a work memory used for operations performed by the CPU 201, and also provides an image memory for temporarily storing image data. The HDD 204 is a hard disk drive, and holds the OS, various types of programs, image data, and so on. The console unit I/F 205 is an interface for connecting the system bus 211 and the console unit 111. The network I/F 206 connects the LAN 100 and the system bus 211, and inputs/outputs information via a network. The scanner I/F 207 controls an interface between the scanner unit 112 and the control unit 200. The image processing unit 208 carries out image processing such as rotation, color conversion, image compression/decompression processes, and so on on image data input from the scanner unit 112 and image data to be output to the printer unit 113. The printer I/F 209 accepts image data processed by the image processing unit 208 and controls printing performed by the printer unit 113 in accordance with attribute data that accompanies the image data. Although this embodiment describes an example in which the MFP can display a UI using the console unit 111, an information processing apparatus such as a generic computer or the like may be employed instead of the MFP 110.

Hardware of License Management Server

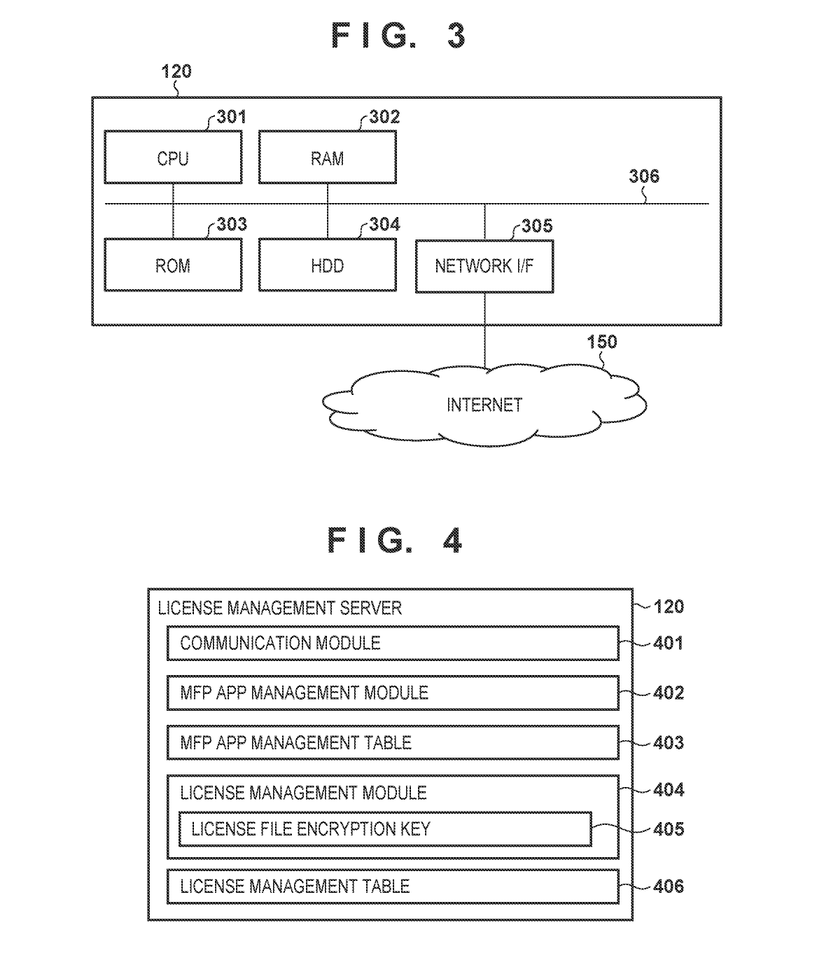

FIG. 3 is a block diagram illustrating the hardware configuration of the license management server 120 according to the embodiment.

The license management server 120 includes a CPU 301, RAM 302, ROM 303, a hard disk drive (HDD) 304, and a network I/F 305, and these units are communicably connected to each other via a system bus 306. The ROM 303 holds a boot program, and when the server power is turned on, the CPU 301 reads out the boot program and loads an OS, control programs, and the like installed in the HDD 304 into the RAM 302. The functions of the license management server 120 are realized by the CPU 301 executing the programs loaded into the RAM 302. The CPU 301 also communicates with other devices on the network to which the server is connected via the network I/F 305. The hardware configurations of the web app server 130 and the PC 140 are the same as the hardware configuration of the license management server 120 illustrated in FIG. 3, and thus descriptions thereof will be omitted.

Software of License Management Server

FIG. 4 is a block diagram illustrating the software module configuration of the license management server 120 according to the embodiment. Programs for realizing these modules are held in the HDD 304 of the license management server 120, and the functions of the modules are realized by loading those programs into the RAM 302 and executing the programs using the CPU 301.

The license management server 120 according to the present embodiment carries out three processes, namely encrypting MFP apps, issuing licenses for installing MFP apps in individual MFPs, and issuing license access numbers for managing individual licenses.

A communication module 401 accepts processing requests by communicating with an external device over a network, and distributes the requests to an MFP app management module 402 and a license management module 404 in accordance with the processing request. The MFP app management module 402 accepts an unencrypted MFP app and encrypts that MFP app. The MFP app management module 402 accepts the MFP app from an application development vendor through a terminal (not illustrated) connected to the Internet 150. The MFP app management module 402 then generates an ID for uniquely identifying the MFP app (“MFP app ID” hereinafter) and a common encryption key for the MFP app, and registers this data in an MFP app management table 403. The MFP app ID is identification information for identifying individual MFP apps. The common encryption key of an MFP app is an encryption key for encrypting the MFP app. The MFP app is encrypted using the common encryption key; the encrypted MFP app and the MFP app ID are sent to the requester. The MFP app management table 403 is a database that stores the MFP app ID and the MFP app common encryption key generated by the MFP app management module 402 in association with each other.

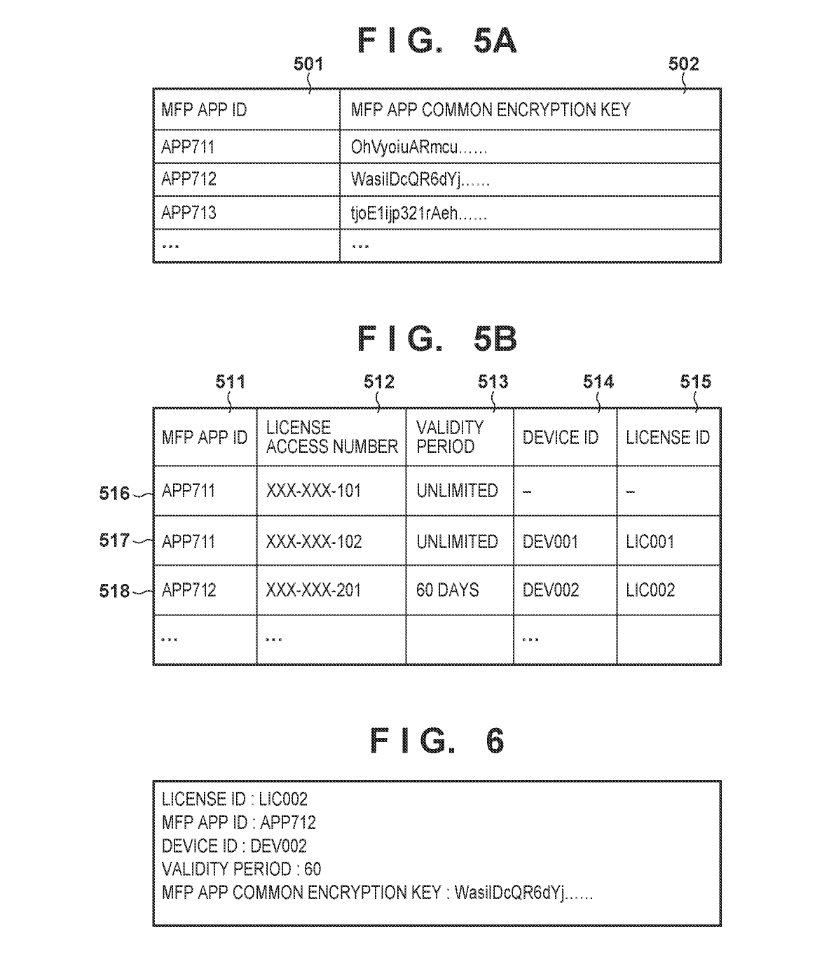

FIG. 5A is a diagram illustrating an example of the MFP app management table 403 according to the embodiment. Column 501 indicates MFP app IDs, and column 502 indicates MFP app common encryption keys.

The license management module 404 issues licenses for installing the MFP apps in respective MFPs, and manages the license access numbers for issuing the licenses. When a request to issue a license access number corresponding to an MFP app being sold is received from a seller who sells the application, the license management module 404 issues the license access number that corresponds to that MFP app. That license access number is then registered in a license management table 406. Here, the “license access number” is a number for uniquely managing a single license for that MFP app, and the seller of the application sells the aforementioned encrypted MFP app along with this license access number. In addition, upon receiving the license access number and a device ID from a purchaser of the MFP app, the license management module 404 issues a license to that purchaser (user). The issuing of the license is a process of referring to the MFP app management table 403 and a license management table 406, and creating a license file corresponding to the license access number.

Here, first, the license management module 404 obtains the corresponding MFP app ID from the received license access number, and obtains the common encryption key of the MFP app associated with the MFP app ID. A license ID is then issued, the device ID and license ID are recorded in the license management table 406, and the license file is generated from these pieces of information as a single file. The license file generated in this manner is then encrypted using an encryption key 405 of the license file held within the license management module 404 and sent to the requester. The encryption key 405 of the license file is the public key of the public key encrypt system. Note that the software of the MFP 110, which will be described later, contains the corresponding secret key. The license management table 406 is a database that stores information related to licenses.

FIG. 5B is a diagram schematically illustrating an example of the license management table 406 according to the embodiment. Column 511 indicates the MFP app ID, column 512 indicates the license access number, and column 513 indicates a validity period, as a number of days, of the license. This number of days indicates for how many days the license is valid from the date when the MFP app is installed in the MFP. Column 514 indicates the device ID (the ID of the MFP in which the MFP app is installed), and column 515 indicates the license ID. Row 516 indicates an example of an MFP app for which the license access number has been issued but the license has not yet been issued, and thus the device ID and the license ID are blank. Row 517 indicates an example of an MFP app for which a license has been issued, where the device ID (DEV001) and the license ID (LIC001) are registered. Row 518 also indicates an example of an MFP app for which a license has been issued, where a validity period of 60 days, the device ID (DEV002), and the license ID (LIC002) are registered.

In this manner, the ID of the MFP app and the device ID of the MFP 110 are registered in association with each other in the license management table 406. Accordingly, which MFP app license has been issued to a given MFP can be known by referring to the license management table 406.

FIG. 6 is a diagram illustrating an example of the license file issued by the license management server 120 according to the embodiment. FIG. 6 indicates an example of a license file corresponding to row 518 in the license management table 406 illustrated in FIG. 5B. Here, the license ID (LIC002), the MFP app ID (APP712), the device ID (DEV002), and the validity period (60 days) are obtained from the license management table 406 illustrated in FIG. 5B. Meanwhile, the common encryption key (WasiIDcQR6dYj . . . ) for the application (APP712) is obtained from the MFP app management table 403 illustrated in FIG. 5A. In this manner, the license file is created by the license management module 404 on the basis of the information obtained from the MFP app management table 403 and the license management table 406. The purchaser of the MFP app can therefore obtain the encrypted license file on the basis of the license access number of the purchased MFP app.

MFP Software

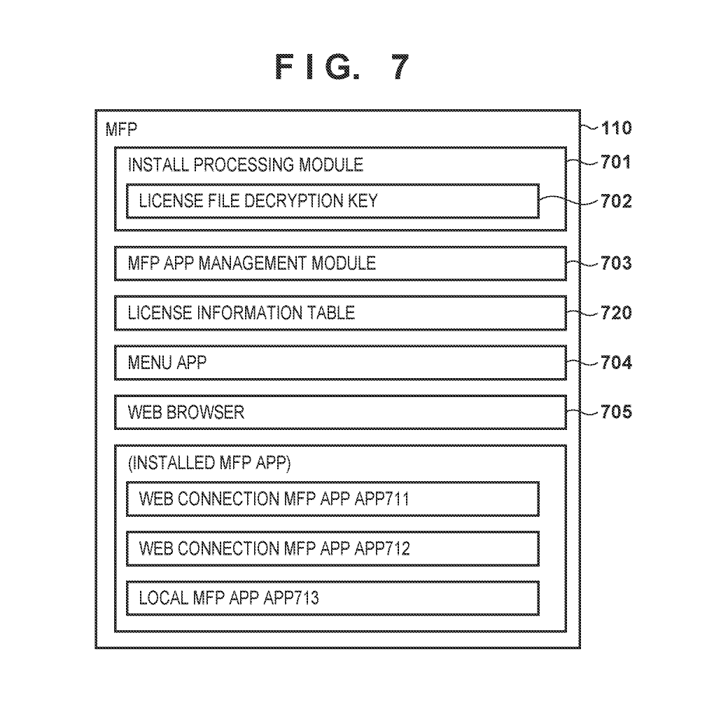

FIG. 7 is a diagram illustrating the software module configuration of the MFP 110 according to the embodiment. The software modules are held in the HDD 204 of the MFP 110, and during execution, are loaded into the RAM 203 and executed by the CPU 201. With an MFP app, in the case where the MFP app is installed in an application platform, the MFP app can also be executed by the application platform. The application platform is a software module, and thus is executed by the CPU in this case as well.

An install processing module 701 controls the installation of the MFP app. The install processing module 701 is connected to the PC 140 via the network I/F 206, and executes the installation of the MFP app in response to an instruction from the PC 140. The install processing module 701 includes a license file decryption key 702 for decrypting the encrypted license file. The license file decryption key 702 corresponds to the aforementioned license file encryption key 405. An MFP app management module 703 manages the MFP apps installed in the MFP 110. A license information table 720 is a database that holds information related to the installed MFP apps and the license files.

FIG. 18 is a diagram schematically illustrating an example of the license information table 720 according to the embodiment. The license information table 720 holds an MFP app ID 1801, a license validity period 1802, a license ID 1803, and a license ID history 1804. The license ID history 1804 is a history of license IDs installed in the past, and is held in order to prevent licenses from being reused.

Row 1811 corresponds to an MFP app having an MFP app ID of “APP711”, and indicates that a license having no limit on the validity period has been issued with a license ID of “LIC010”. Row 1812 corresponds to an MFP app having an MFP app ID of “APP712”, and indicates that a license having a validity period of Dec. 10, 2016 has been issued with a license ID of “LIC002”. This row also indicates that a license having a license ID of “LIC003” has been installed in the past. Row 1813 corresponds to an MFP app having an MFP app ID of “APP713”, and indicates that a license having no limit on the validity period has been issued with a license ID of “LIC011”.

A menu app 704 displays a GUI for selecting and executing an MFP app installed in the MFP 110. A web browser 705 communicates with the web app server 130. The web browser 705 sends requests to the web app server 130 using the HTTP protocol, renders HTML data (screen information) returned as responses to the requests and displays the rendered data in the console unit 111, and analyzes and executes JavaScript (trade name) returned as a response.

Next, the installation of an MFP app by the purchaser of the MFP app will be described. The user uses the PC 140 to send an encrypted application (application program file) and an encrypted license file to the install processing module 701. Using the received files, the install processing module 701 carries out a process for installing the MFP app. At this time, first, the install processing module 701 decrypts the license file using the license file decryption key 702. Then, using the common encryption key of the MFP app included in the decrypted license file, the install processing module 701 decrypts the encrypted MFP app. The MFP app decrypted in this manner is passed to the MFP app management module 703 and saved in the HDD 204. At this time, the device ID recorded in the decrypted license file is compared with the device ID set in advance for the MFP 110, and it is determined whether or not the license file is correct. Additionally, a date at which the MFP app will become invalid is calculated from the validity period denoted in the license file and the current date, and is then managed by the MFP app management module 703 as a validity period date.

In FIG. 7, as an example of the embodiment, it is assumed that three MFP apps, namely APP711, APP712, and APP713, are installed. Note that two types of MFP apps, namely a web connection MFP app and a local MFP app, are defined as MFP apps in the present embodiment. The term “MFP app” is a term collectively referring to the web connection MFP apps and the local MFP apps. APP711 and APP712 are web connection MFP apps, whereas APP713 is a local MFP app.

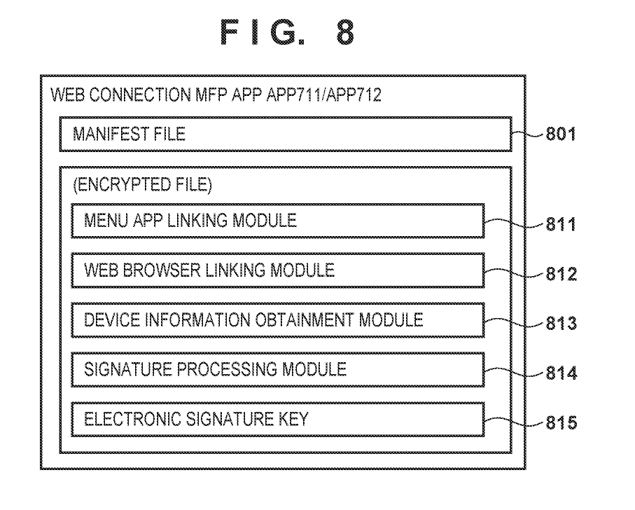

The web connection MFP app is an app through which a function provided by a web app located in a web server is executed from the MFP 110. The web connection MFP app connects to the web app using the web browser 705, and executes the function provided by the web app from the MFP 110. The web connection MFP app will be described in detail later with reference to FIG. 8.

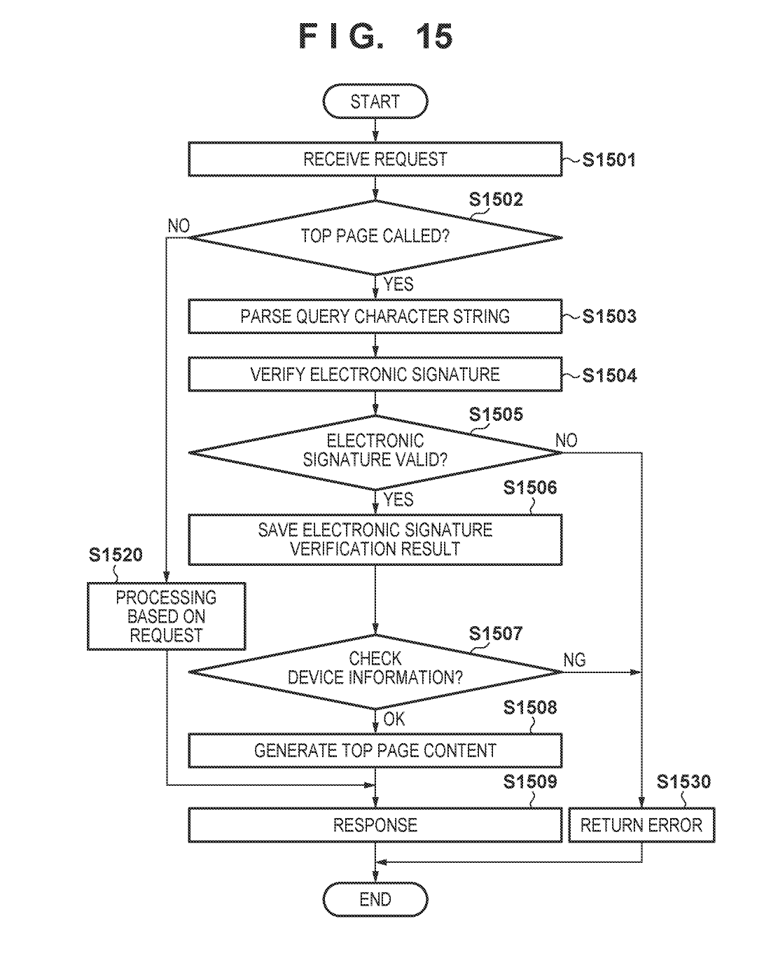

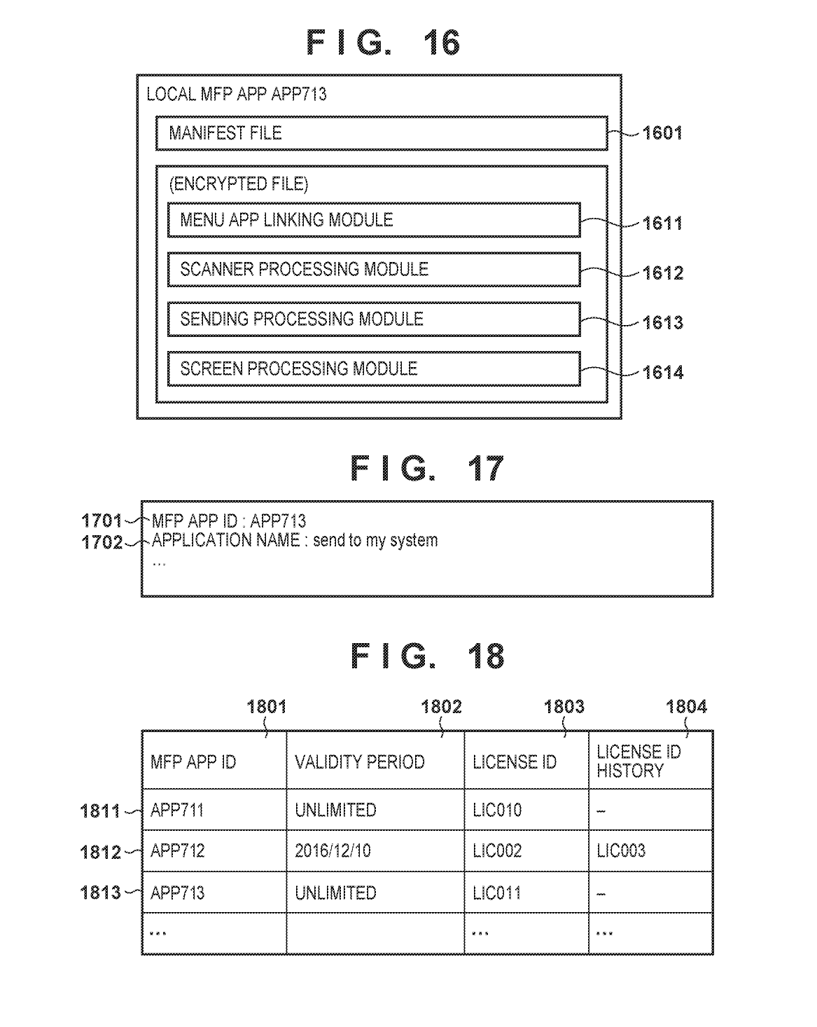

On the other hand, the local MFP app is an app that provides functions using the scanner unit 112, the printer unit 113, the image processing unit 208, and so on of the MFP 110 to the MFP 110 as software modules. By calling a software module held by the local MFP app, the function provided by the local MFP app is executed by the MFP 110. The local MFP app will be described in detail later with reference to FIG. 16. Note that the types and numbers of MFP apps installed in the MFP vary from MFP to MFP.

The MFP app is a program written in Java (trade name), for example, and is installed in a platform, provided in the MFP 110, that takes the Java (trade name) operating environment as a base, for example.

Local MFP App

FIG. 16 is a diagram illustrating the software module configuration of a local MFP app according to the embodiment. Local MFP apps have different software module configurations depending on the function provided. As one example, FIG. 16 illustrates the software module configuration of a local MFP app that provides a function for sending a document read by the scanner unit 112 to the exterior through the network I/F 206. The software modules indicated in FIG. 16 are held in the HDD 204 of the MFP 110, and at the time of execution, are loaded into the RAM 203 and executed by the CPU 201. The local MFP app includes a manifest file 1601 that is not subject to encryption when the MFP app management module 402 encrypts the MFP app, and an application program file main portion that is subject to the encryption.

The manifest file 1601 is a file included in the MFP app regardless of the function of the MFP app, and is a file denoting basic information of the MFP app. FIG. 17 illustrates an example of the manifest file according to the embodiment. An MFP app ID 1701 and an application name 1702 are defined in the manifest file. The MFP app ID 1701 is the same ID as that managed by the MFP app management table 403. The application name 1702 indicates the name of the MFP app. This basic information can be referred to without decryption even if the application program file main portion is encrypted.

A processing module based on the function of the MFP app is included in the application program file main portion. A menu app linking module 1611 is a module linked to the menu app 704, and a GUI button for calling the local MFP app is registered in the menu app 704. A scanner processing module 1612 is a module for reading a document using the scanner unit 112. A sending processing module 1613 is a module for sending the document read by the scanner processing module 1612 to the exterior via the network I/F 206. A screen processing module 1614 is a module for displaying the operating screen of the local MFP app APP713 in the console unit 111.

Different local MFP apps implement different functions, and thus it is necessary for the application development vendor to program software modules for realizing the functions on an app-by-app basis.

By sending a created local MFP app to the license management server 120, the software modules aside from the manifest file 1601 are encrypted and consolidated as a single file. By using the encryption function of the application, the application development vendor can prevent third parties from analyzing the content of the application.

Web Connection MFP App

FIG. 8 is a diagram illustrating the software module configuration of the web connection MFP app according to the embodiment. The web connection MFP app holds necessary setting information for each web app in a manifest file 801, an electronic signature key 815, and so on. In other words, a single web connection MFP app is necessary for a corresponding single web app. A web connection MFP app corresponding to the web app to be used is installed in the MFP 110. In the case where a plurality of web apps is used, a plurality of web connection MFP apps are installed in the MFP 110. In this case, the plurality of web connection MFP apps share the single web browser 705. The web connection MFP app also includes the manifest file 801 that is not subject to encryption when the MFP app management module 402 encrypts the MFP app, and an application program file main portion that is subject to the encryption. The software modules indicated in FIG. 8 are held in the HDD 204 of the MFP 110, and at the time of execution, are loaded into the RAM 203 and executed by the CPU 201.

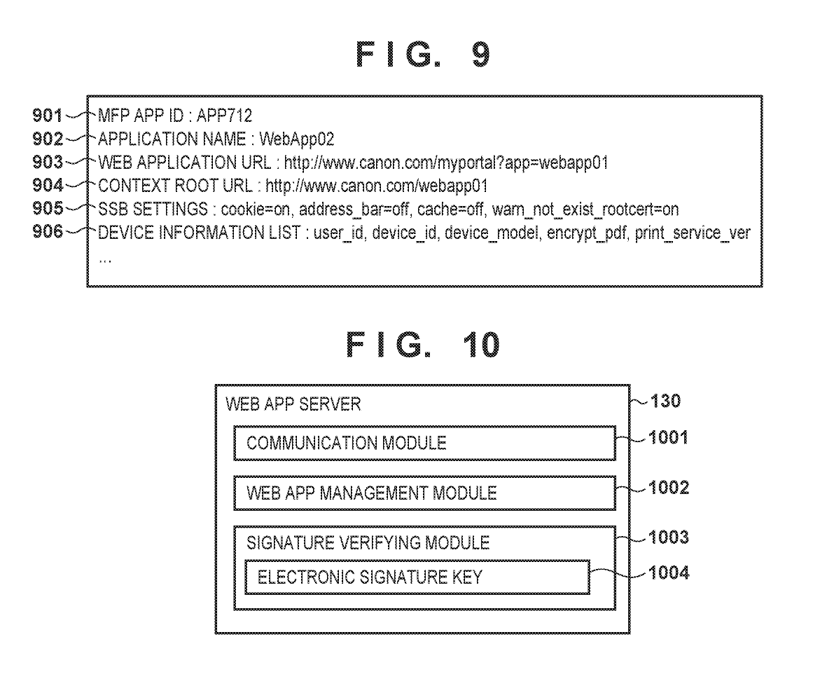

The manifest file 801 is a file denoting the basic information of the MFP app and information for connecting to the web app. FIG. 9 illustrates an example of the manifest file according to the embodiment. An MFP app ID 901, an application name 902, a web application URL 903, a context root URL 904, SSB settings 905, and a device information list 906 are defined in the manifest file.

The MFP app ID 901 and the application name 902 have the same definitions as those in the manifest file 1601 of the local MFP app indicated in FIG. 17. The web application URL 903, the context root URL 904, the SSB settings 905, and the device information list 906 are information unique to web connection MFP apps.

The web application URL 903 indicates the URL of the top page of the web app. In other words, the web application URL 903 indicates access destination information for receiving the service of the web app. The context root URL 904 indicates the root path of the web app. The SSB (site specific browser) settings 905 indicate setting values set in the web browser when the MFP app connects to the web app. The SSB settings include settings pertaining to a web browser UI and settings pertaining to communication. Hiding a toolbar, limiting URL inputs, limiting the addition of bookmarks, and so on can be given as examples of the settings pertaining to the web browser UI. A method for processing cookies, limiting the display of HTTPS/HTTP mixed pages, permitting/prohibiting cache usage, and so on can be given as examples of the settings pertaining to communication. Making the SSB settings for each MFP app connecting to the web app makes it possible to configure a dedicated web browser on a web app-by-web app basis. Not defining the SSB settings 905 in the manifest file is also permitted in the case where the SSB settings are not used. The device information list 906 indicates a list of device information communicated when calling the top page of the web app. The “device information” is information pertaining to the MFP 110, such as information specifying the make and model of the MFP 110, optional functions active in the MFP 110, usernames of users who are logged in, the software version, and so on. Not defining the device information list 906 in the manifest file is also permitted in the case where it is not necessary to obtain the device information. The information recorded in the manifest file is information uniquely associated with each corresponding MFP app.

In the application program file main portion, a menu app linking module 811 is a module linked to the menu app 704, and a GUI button for calling the web connection MFP app is registered in the menu app 704. A web browser linking module 812 is a module for operating the web browser 705, and passes the URL of the web app to the web browser 705, displays the web browser 705 in a front panel of the console unit 111, and so on. A device information obtainment module 813 obtains the device information specified in the device information list 906. A signature processing module 814 generates an electronic signature attached when connecting to the web app. The electronic signature is generated by the electronic signature key 815. The electronic signature is used by the web app to check that the call has been made from the web connection MFP app. The web app can omit this check freely. In this case, the electronic signature is unnecessary, and the web connection MFP app is configured without the electronic signature key 815.

Note that only the content of the manifest file 801 and the electronic signature key 815 differ among individual web connection MFP apps, and the other software modules are the same for all web connection MFP apps. In other words, by reusing software modules, web connection MFP apps can be created simply by defining the information pertaining to the web app. For example, a web connection MFP app can be created easily by preparing a tool that outputs a web connection MFP app upon information pertaining to a web app being input.

By sending a created web connection MFP app to the license management server 120, the software modules aside from the manifest file 801 are encrypted and consolidated as a single file. By using the encryption function of the application, the application development vendor can prevent third parties from analyzing the content of the application. This also makes it possible to prevent the electronic signature key 815 contained therein from being extracted.

Web App Server Software

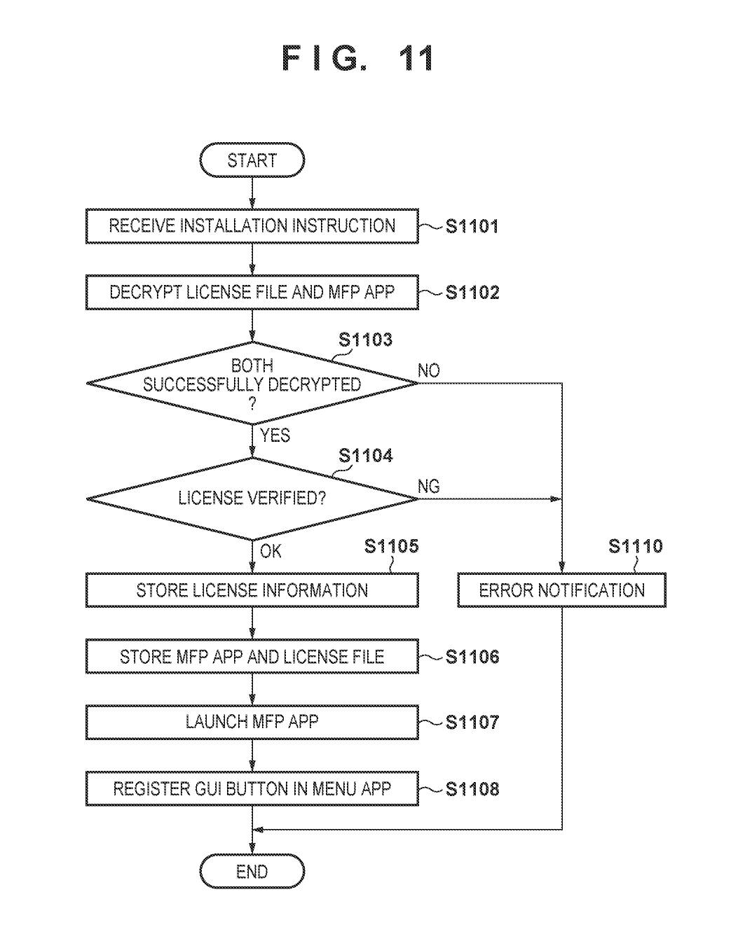

FIG. 10 is a diagram illustrating the software module configuration of the web app server 130 according to the present embodiment. These software modules are held in the HDD 304 of the web app server 130, and the functions of the software modules are realized by being loaded into the RAM 302 at the time of execution and executed by the CPU 301.

A communication module 1001 communicates with an external device over a network so as to receive requests, make responses, and so on. A web app processing module 1002 generates HTML content to be displayed by the web browser 705 of the MFP 110, generates content for operating MFP 110, and so on in response to an HTTP protocol request from the MFP 110. A signature verifying module 1003 includes an electronic signature key 1004 corresponding to the electronic signature key 815 included in the web connection MFP app illustrated in FIG. 8, and verifies electronically-signed information using this key. Whether or not the request is one from the MFP 110 in which the web connection MFP app has been installed can be determined by verifying the electronic signature. For example, in the present embodiment, it is assumed that Hash-based Message Authentication Code (HMAC) is used for the electronic signature technology. In other words, the electronic signature key 815 and the electronic signature key 1004 are the same secret key (common key). Note that other technology may be used for the electronic signature. For example, in the case where a digital signature is used as the electronic signature technology, the digital signature is a public key encryption method, and thus the electronic signature key 815 of the web connection MFP app is the private key, and the electronic signature key 1004 of the web app server 130 is the public key corresponding to that private key.

MFP App Installation Process

FIG. 11 is a flowchart illustrating a process carried out by the MFP 110 for installing an MFP app. The steps in the flowchart illustrated in FIG. 11 are executed by the CPU 201 reading out to the RAM 203, analyzing, and executing programs stored in the HDD 204 of the MFP 110. It is assumed that the purchaser of the MFP app has, as described earlier, received the encrypted MFP app and license access number from the seller of the MFP app, received the license file from the license management server 120, and stored these items in the PC 140 as advance preparations.

First, the install processing module 701 receives the encrypted MFP app and the encrypted license file as an installation instruction from the PC 140 operated by the purchaser of the MFP app (step S1101). The install processing module 701 decrypts the received license file using the license file decryption key 702. Then, using the common encryption key of the MFP app included in the decrypted license file, the encrypted MFP app is decrypted (step S1102). Here, in the case where the MFP app is a web connection MFP app, the menu app linking module 811, the web browser linking module 812, the device information obtainment module 813, and the signature processing module 814, as well as the file of the electronic signature key 815, are decrypted. On the other hand, in the case where the MFP app is a local MFP app, the menu app linking module 1611, the scanner processing module 1612, and the sending processing module 1613 are decrypted.

The install processing module 701 checks whether or not both the license file and the MFP app have been successfully decrypted (step S1103). In the case where both have been successfully decrypted, the install processing module 701 advances the process to step S1104. In the case where one or both have not been successfully decrypted, the install processing module 701 issues an error notification (step S1110) and ends the process.

In step S1104, the install processing module 701 compares the device ID denoted in the decrypted license file with the device ID set in advance for the MFP 110, and determines whether or not the license file correctly matches that MFP 110. The install processing module 701 advances the process to step S1105 upon determining that the license file is correct. However, the install processing module 701 issues an error notification (step S1110) and ends the process upon determining that the license file is incorrect.

In step S1105, the install processing module 701 stores license information in the license information table 720. The “license information” includes the MFP app ID, the license ID, and the license validity period. Here, the install processing module 701 calculates the date at which the MFP app will become invalid from the validity period recorded in the license file and the current date, and registers that date as the license validity period. In the case where the validity period recorded in the license file is unlimited, the validity period is correspondingly registered as being unlimited.

Next, the install processing module 701 saves the decrypted MFP app and license file in the HDD 204. The install processing module 701 then reads out the MFP app saved in the HDD 204 to the RAM 203 and launches the MFP app (step S1107). The launched MFP app registers a GUI button for calling the MFP app in the menu app (step S1108). At this time, in the case where the launched MFP app is a web connection MFP app, the menu app linking module 811 carries out the process of step S1107. On the other hand, in the case where the launched MFP app is a local MFP app, the menu app linking module 1611 carries out the process of step S1107. Furthermore, the process of step S1108 is skipped without displaying a screen in the console unit 111 in the case of the local MFP app, which does not require a GUI button to be registered in the menu app.

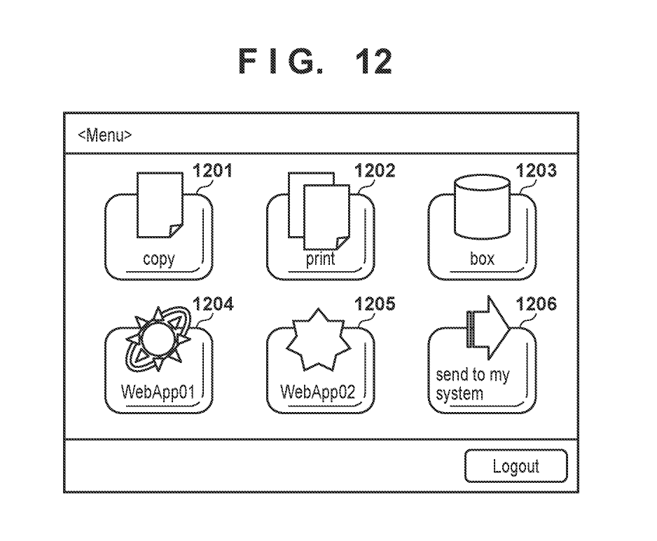

FIG. 12 is a diagram illustrating an example of a GUI displayed in the console unit 111 when the menu app 704 of the MFP 110 is called in a state where the MFP apps APP711, APP712, and APP713 have been installed in the MFP 110, according to the embodiment. GUI buttons 1201, 1202, and 1203 are GUI buttons for calling application provided in the MFP 110 from the outset.

A GUI button 1204 is a GUI button for calling the web connection MFP app APP711. A GUI button 1205 is a GUI button for calling the web connection MFP app APP712. A GUI button 1206 is a GUI button for calling the local MFP app APP713. As illustrated in FIG. 12, the menu app 704 displays the GUI button regardless of the type of the MFP app.

The GUI buttons can be selected only during the period for which the license is valid. For example, in the case where the APP712 has been installed with a license valid for 60 days, the GUI button 1205 is active until the 60th day after the installation, but the GUI button 1206 is inactive from the 61st day on. When the GUI button 1206 is deactivated, the MFP app APP712 corresponding thereto can no longer be called, and thus the web app cannot be connected to.

Processing by Menu App

FIG. 19 is a flowchart illustrating a process carried out in response to the menu app 704 installed in the MFP 110 having received a call instruction. The menu app 704 confirms the licenses of the MFP apps corresponding to the GUI buttons and enables only the buttons of the MFP apps having valid licenses to be selected. The steps in the flowchart illustrated in FIG. 19 are executed by the CPU 201 reading out to the RAM 203, analyzing, and executing programs stored in the HDD 204 of the MFP 110.

The menu app 704 receives the call instruction (step S1901), and creates a list of the GUI buttons registered in the menu app 704 (step S1902). The call instruction is output, for example, when the MFP 110 is started up, in response to a predetermined operation made by the user, or the like. Next, the menu app 704 repeats the processes from step S1903 to step S1908 for each GUI button, in order to verify the validity of the listed GUI buttons.

The menu app 704 determines whether or not the GUI button is a GUI button corresponding to an application provided from the outset (step S1904). The process advances to step S1906 if the GUI button corresponds to an application provided from the outset, whereas the process advances to step S1905 if the GUI button corresponds to an MFP app installed later. In step S1905, the menu app 704 uses the license information table 720 to determine the validity period of the license for the MFP app corresponding to the GUI button. In other words, the validity of the license is determined. The process advances to step S1906 if the license is within the validity period, whereas the process advances to step S1907 if the license is outside the validity period. In step S1906, the menu app activates the GUI button. On the other hand, in step S1907, the menu app deactivates the GUI button. To deactivate the GUI button, the GUI button itself may be hidden, or the GUI button may be displayed but disabled from being pressed, for example. Alternatively, a message indicating that the license is outside the validity period may be displayed after the GUI button is pressed. Once the process has ended for all of the GUI buttons, the menu app 704 advances the process to step S1909. Finally, the menu app 704 displays the menu app screen illustrated in FIG. 12 in the console unit 111, and then ends the process (step S1909). After the GUI button displayed by the menu app has been operated and the MFP app executed, the menu app is called to once again return to the menu screen, and FIG. 19 is executed. Accordingly, the validity period of licenses is checked for MFP apps not included as standard each time the menu screen is displayed.

Processing by Local MFP App

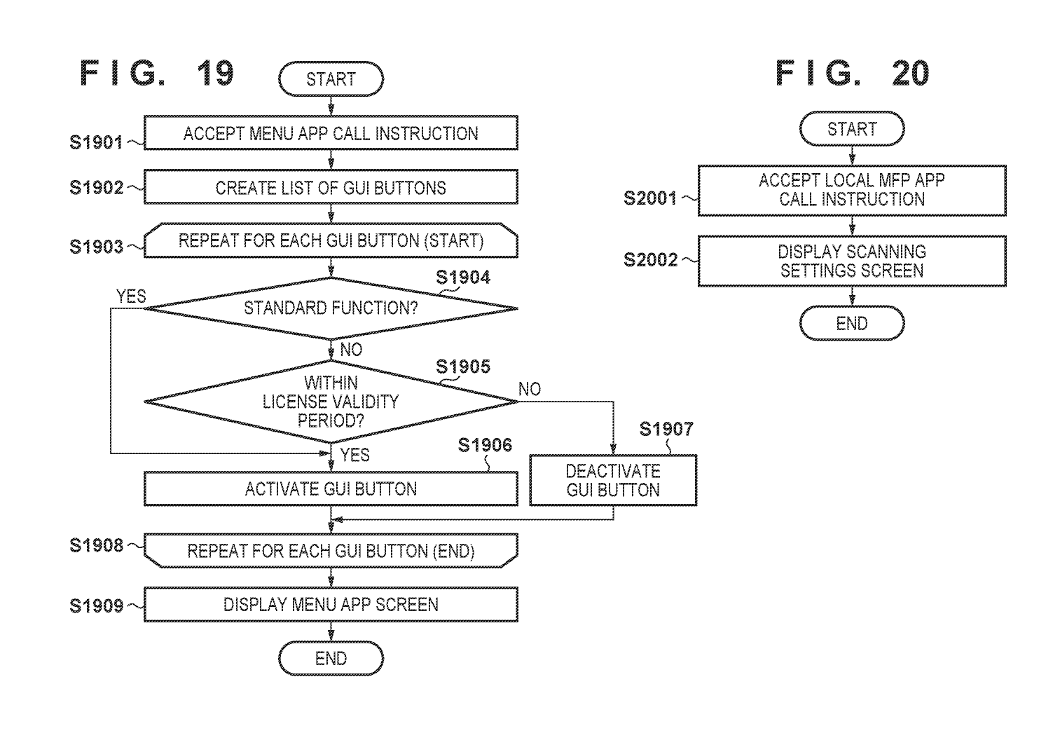

FIG. 20 is a flowchart illustrating a process carried out when the local MFP app has received a call instruction from the screen illustrated in FIG. 12. The steps in the flowchart illustrated in FIG. 20 are executed by the CPU 201 reading out to the RAM 203, analyzing, and executing programs stored in the HDD 204 of the MFP 110. Here, a case in which the local MFP app APP713 illustrated in FIG. 16 has received the call will be described as an example.

The menu app linking module 1611 of the local MFP app receives the call instruction from the menu app 704, which has accepted a GUI button being pressed by the user (step S2001). Next, the screen processing module 1614 displays a scanning settings screen, which is a default screen of the local MFP app APP713, in the console unit 111, and ends the process (step S2002). Here, the process of step S2002 is a process based on the function of the local MFP app.

Calling and Execution of Web App

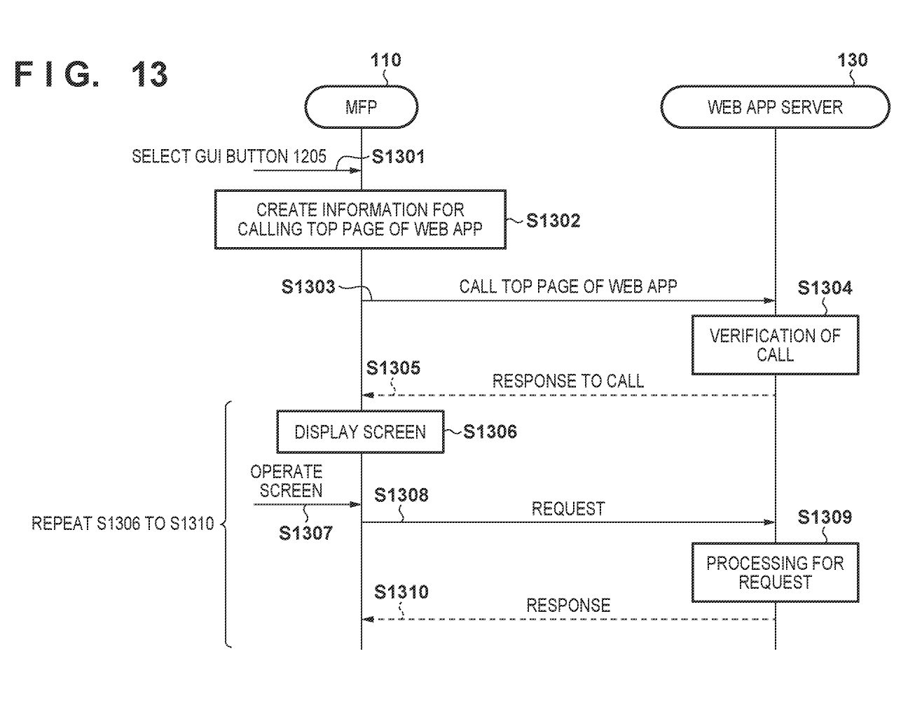

FIG. 13 is a sequence chart illustrating the flow of a series of processes carried out when the web app is used from the MFP 110. Here, processing carried out in a case where the GUI button 1205 displayed in the menu app 704 has been selected by the user will be described as an example.

First, when the menu app 704 of the MFP 110 accepts the GUI button 1205 being pressed by the user, the MFP app APP712 corresponding to the GUI button 1205 is called (step S1301). The called MFP app APP712 creates information necessary for calling the top page of the web app on the basis of the information defined in manifest file of the MFP app APP712 (step S1302). The information necessary for calling the top page of the web app includes the device information defined by the device information list 906, the electronic signature created using the electronic signature key 815, and so on. Next, the MFP app APP712 calls the top page of the web app on the basis of the information created in step S1302, using the web browser 705 in a state in which the SSB settings 905 defined in the manifest file are active (step S1303).

In response to the call, the web app server 130 carries out verification for the call (step S1304). As the “verification for the call”, for example, the validity of the electronic signature is checked in order to confirm that the call is a call from the MFP 110 in which the web connection MFP app APP712 is installed. Then, using the result of the verification, the web app server 130 issues a response to the call to the MFP 110 (the web browser 705) (step S1305). This response includes, as a verification result, information indicating OK (verification successful) or NG (verification failure), for example. If the verification result is “OK”, the web app server 130 returns HTML content for creating the screen necessary for the next operation.

The web browser 705 renders the received HTML, and displays the screen in the console unit 111 (step S1306). Then, upon receiving a screen operation instruction from the user (step S1307), the web browser 705 sends a corresponding request to the web app server 130 using the HTTP protocol (step S1308).

Having received the request, the web app server 130 carries out a process in response to the request (step S1309), and, on the basis of the processing result, returns HTML content for creating the next screen to the MFP 110 (the web browser 705) (step S1310). The processes from step S1306 to step S1310 are repeated thereafter to realize the processing and screen transitions of the web app.

FIG. 14 is a flowchart illustrating a process carried out when the web connection MFP app calls the top page of the web app. The steps in the flowchart illustrated in FIG. 14 are executed by the CPU 201 reading out to the RAM 203, analyzing, and executing programs stored in the HDD 204 of the MFP 110. The flowchart in FIG. 14 illustrates the processes from step S1301 to step S1303 of FIG. 13 in detail. Step S1301 of FIG. 13 corresponds to step S1401 of FIG. 14. Step S1302 of FIG. 13 corresponds to step S1402 to step S1411 of FIG. 14. Step S1303 of FIG. 13 corresponds to step S1412 of FIG. 14.

The menu app linking module 811 of the web connection MFP app receives a call instruction from the menu app 704, which has accepted the GUI button being pressed by the user (step S1401). Next, the web browser linking module 812 obtains the top page URL 903, the SSB settings 905, and the device information list 906, which are the information of the web app, from the manifest file 801 (step S1402). Note that depending on the web connection MFP app, the SSB settings 905 and the device information list 906 may not be defined in the manifest file 801. In this case, only the defined information is obtained.

If the device information list 906 has been obtained in step S1402, the device information obtainment module 813 obtains the device information listed in the device information list 906 (steps S1403 and S1404). According to the manifest file 801 indicated in FIG. 9, the device information obtainment module 813 obtains the device information corresponding to user_id, device_id, device_model, encrypt_pdf, and print_service_ver. user_id indicates the ID of the user logged into the MFP 110. device_id indicates the device ID of the MFP 110. device_model indicates the model of the MFP 110. encrypt_pdf indicates the state of the activation of a PDF encryption option. print_service_ver indicates the software version of a web service module for requesting the MFP 110 to carry out printing from the web app. The device information list 906 indicated in FIG. 9 is merely an example, and the device information that can be obtained is not intended to be limited thereto.

Next, the signature processing module 814 creates the electronic signature in the case where the electronic signature key 815 is included in the web connection MFP app (steps S1405 and S1406). The signature processing module 814 calculates a message digest (HMAC value) using a hash function that takes a signature character string as a message and the electronic signature key 815 as a private key, and uses that digest as the electronic signature. The signature character string is a character string created by connecting the top page URL 903, the system time of the MFP 110 (“timestamp” hereinafter), and if obtained in step S1404, the device information obtained in step S1404.

Next, the web browser linking module 812 assembles a URL for calling the top page of the web app (step S1407). If the device information obtained in step S1404 is present, the web browser linking module 812 adds that information to the top page URL 903 as a query character string. Furthermore, if the timestamp and electronic signature obtained in step S1406 are present, the web browser linking module 812 also adds that information to the top page URL 903 as a query character string.

The web browser linking module 812 determines whether or not the SSB settings 905 have been obtained (step S1408). If the SSB settings have not been obtained, the SSB settings of the web browser 705 are deleted, and the various settings of the web browser are returned to their default states (step S1420). On the other hand, if the SSB settings have been obtained in step S1402, the web browser linking module 812 applies those SSB settings to the web browser 705 (step S1409). According to the SSB settings 905 indicated in FIG. 9, the web browser linking module 812 applies SSB settings corresponding to cookie, address_bar, cache, and warn_not_exist_rootcert to the web browser 705. cookie=on indicates that cookies are enabled. address_bar=off indicates that the address bar for inputting a URL from the web browser UI is hidden. cache=off indicates that the cache will not be used. warn_not_exist_rootcert=on indicates that a warning is to be displayed in the case where no root certificate exists at the time of encrypted communication. The SSB settings 905 indicated in FIG. 9 are merely an example, and the SSB settings that can be specified are not intended to be limited thereto.

Next, the web browser linking module 812 sets the URL assembled in step S1407 in the web browser 705 as a connection destination (step S1410). The web browser linking module 812 switches the display of the console unit 111 from the menu app 704 to the GUI window of the web browser 705 (step S1411). The web browser 705 displayed in the console unit 111 calls the top page of the web app, and thus the URL set in step S1410 is accessed (step S1412).

By executing the processing described above, the web connection MFP app corresponding to the GUI button specified in the menu app 704 can call the top page of the web app.

Request Process Carried out by Web App Server

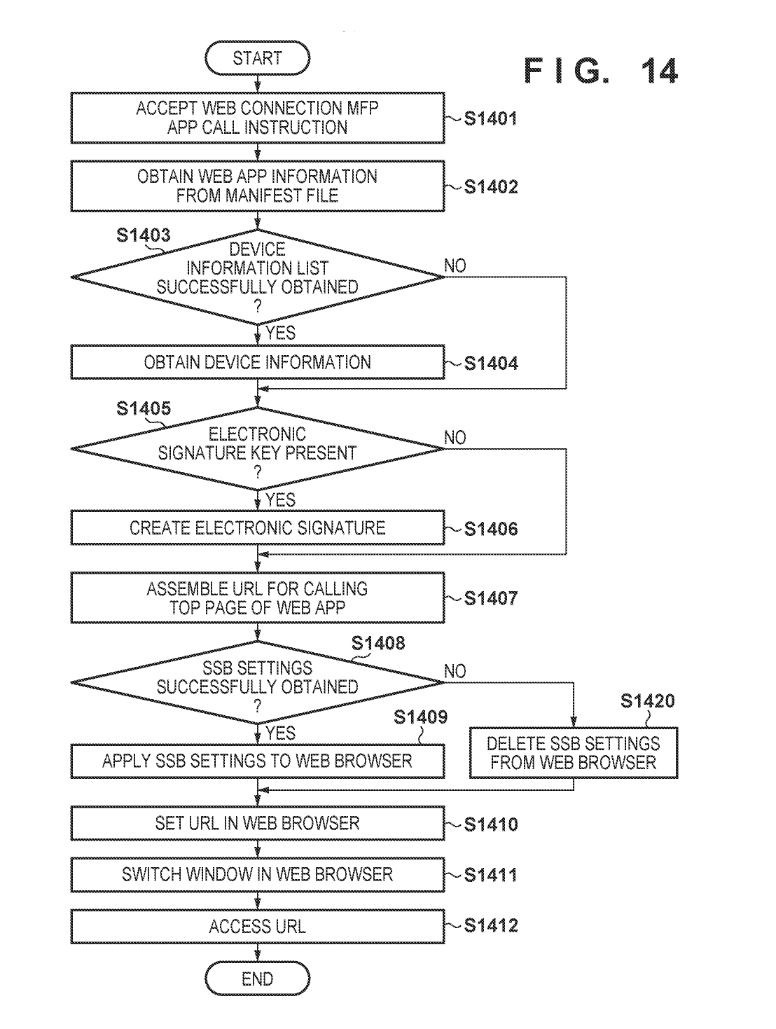

FIG. 15 is a flowchart illustrating a process executed in the case where the web app server 130 has received an HTTP request from the MFP 110. The steps in the flowchart illustrated in FIG. 15 are executed by the CPU 301 reading out to the RAM 303, analyzing, and executing programs stored in the HDD 304 of the web app server 130.

The flowchart illustrated in FIG. 15 describes in detail the processes of steps S1303 to S1305 and steps S1308 to S1310 of FIG. 13. Step S1303 of FIG. 13 corresponds to step S1501 to step S1502 of FIG. 15. Step S1304 of FIG. 13 corresponds to step S1503 to step S1508 of FIG. 15. Step S1305 of FIG. 13 corresponds to step S1509 of FIG. 15. Step S1308 of FIG. 13 corresponds to step S1501 to step S1502 of FIG. 15. Step S1309 of FIG. 13 corresponds to step S1520 of FIG. 15. Step S1310 of FIG. 13 corresponds to step S1509 of FIG. 15.

First, the communication module 1001 receives an HTTP request from the MFP 110 (step S1501). Next, the web app processing module 1002 determines whether or not the received request is a call for the top page. In the case where the request is a call for the top page, the process advances to step S1503, whereas when such is not the case, the process advances to step S1520 (step S1502).

In step S1520, the web app processing module 1002 carries out processing in accordance with the request received in step S1501. For example, in the case of a request for calling the scanning settings screen, HTML for constructing the scanning settings screen is generated. The communication module 1001 then communicates the result of the processing carried out in step S1520 to the MFP 110, and ends the process (step S1509).

On the other hand, in step S1503, the web app processing module 1002 analyzes the query character string included in the request received in step S1501, and extracts the various items therefrom. In the present embodiment, it is assumed that the electronic signature, the timestamp, and the device information are the items obtained, and the following descriptions will be given based on that assumption.

Next, the signature verifying module 1003 verifies the electronic signature extracted in step S1503 (step S1504). Specifically, the signature verifying module 1003 calculates a message digest using a hash function that takes the signature character string as a message and the electronic signature key 1004 as a private key, and determines the signature to be valid in the case were the calculated value matches the electronic signature extracted in step S1503. The signature character string is a character string created by connecting the requested URL received in step S1501 to the timestamp and the device information extracted in step S1503. In other words, the same process as the process carried out by the MFP 110 to create the electronic signature in step S1406 of FIG. 14 is carried out by the web app server 130, and the validity of the electronic signature is confirmed on the basis of whether or not the results match. The results match in the case where the electronic signature key 815 held by the MFP 110 is the same as the electronic signature key 1004 held by the web app server 130. If the results match, the request can be considered to be a request from the MFP 110 in which the web connection MFP app is installed.

If the electronic signature is invalid, the web app processing module 1002 returns an error response to the requester and ends the process (step S1530). On the other hand, if the electronic signature is valid, the web app processing module 1002 saves the verification result for the electronic signature in association with the session (step S1506). Saving the verification result for the electronic signature in association with the session makes it possible to confirm communication from the MFP 110 in which the web connection MFP app is installed when processing subsequent requests. Note that depending on the web app, the requester may be checked using other information aside from the electronic signature. In this case, steps S1504 to S1506 are skipped, and that other information is checked instead. For example, the IP address of the requester, the user agent of the web browser, or the like may be checked, or the device information extracted in step S1503 may be checked.

In step S1507, the web app processing module 1002 checks the device information extracted in step S1503. This step is not necessary if the web app does not require the device information of the MFP 110. If, however, the web app requires the device information of the MFP 110, the web app processing module 1002 checks the device information. If there is a problem, an error is returned to the requester as a response, and the process is ended (step S1530). On the other hand, if there is no problem with the device information, the web app processing module 1002 advances the process to the following step S1508. Confirming the user ID, confirming active optional functions, confirming the software version, and so on can be given as examples of checking the device information.

In step S1508, the web app processing module 1002 generates HTML content for displaying the top page. Finally, the communication module 1001 returns the HTML content generated in step S1508 to the MFP 110 as a response, and ends the process (step S1509).

The procedure described thus far makes it possible to manage licenses for web apps in the same manner as for MFP apps installed in an information processing apparatus. To use a plurality of local MFP apps in the MFP 110, it is necessary to install each of those local MFP apps in the MFP 110. Likewise, in order to use a plurality of web apps in the MFP 110, it is necessary to install web connection MFP apps corresponding to each of those web apps in the MFP 110. In order to install MFP apps in the MFP 110, licenses are necessary for each of the MFP apps to be installed. Because local MFP apps and web connection MFP apps are both MFP apps, the same kind of license management can be implemented. Compared to a case where the license management for web apps is carried out on the server side, a dedicated license management system for web apps is provided in the MFP, or the like, the license management can be carried out with the licenses managed collectively as MFP app licenses, which improves the convenience for sellers, administrators, and so on.

### Other Embodiments

Although the foregoing embodiment describes the web connection MFP app as calling the web browser, the web browser may be called using, for example, WebView. Using WebView makes it possible to call the function of the web browser from within an application.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-152292, filed Aug. 2, 2016, which is hereby incorporated by reference herein in its entirety.

What is claimed is:

1. An information processing apparatus comprising:
a platform for executing an installed application program; and
a license management unit that determines whether a license of the installed application program is valid and permits the application program to be executed if the license is determined to be valid,
wherein in response to a call instruction, the license management unit determines whether or not a license of a first application program is valid, and permits the first application program to be executed if the license is determined to be valid, wherein the first application program is installed with the license, uniquely associated with access destination information for calling a specific web application, and accesses an access destination specified in the access destination information.

2. The information processing apparatus according to claim 1,
wherein the license management unit further determines whether a license of a second application program, installed with the license and that uses a function of the information processing apparatus, is valid, and permits the second application program to be executed if the license is determined to be valid.

3. The information processing apparatus according to claim 1,
wherein the first application program has been installed.

4. The information processing apparatus according to claim 3,
wherein the first application program corresponding to a first web application and the first application program corresponding to a second web application that is different from the first web application are installed.

5. The information processing apparatus according to claim 1, further comprising:
a display that displays a screen; and
a browser that can access a specified access destination, obtain screen information and display the screen information in a screen, and can accept an operation through the screen and send the operation to the access destination,
wherein the first application program accesses the access destination using the browser.

6. The information processing apparatus according to claim 5,
wherein the platform executes the first application program and obtains additional information of the information processing apparatus, and sends the additional information to the access destination using the browser.

7. The information processing apparatus according to claim 6,
wherein the additional information includes device information of the information processing apparatus.

8. The information processing apparatus according to claim 6,
wherein the additional information includes an electronic signature.

9. The information processing apparatus according to claim 5,
wherein the platform executes the first application program and configures the browser.

10. The information processing apparatus according to claim 1,
wherein when the first application program is installed, the platform adds a button for launching the first application program to a menu screen, and the call instruction is triggered by the button being pressed.

11. The information processing apparatus according to claim 1, further comprising:
a scanner unit and a printer unit; and
a providing unit that provides functions of the scanner unit and the printer unit to the web applications.

12. An information processing apparatus, in which is installed a device application associated with an access destination for receiving a service from a specific web application, that manages a license of the web application by managing a license of the device application.

13. A non-transitory computer-readable medium in which is recorded a program to be installed in an information processing apparatus including a license management unit that determines whether a license of an installed program is valid and permits the program to be executed in the case where the license is determined to be valid,
wherein access destination information for calling a specific web application is uniquely associated; and
the program causes the information processing apparatus to access an access destination indicated by the access destination information and call the web application in response to a call instruction.

14. The medium according to claim 13,
wherein the information processing apparatus further includes a web browser; and
the access destination is accessed using the web browser.

15. An application management method executed by an information processing apparatus having a platform for executing an installed application program, the method comprising:
determining whether a license of the installed application program is valid and permitting the application program to be executed if the license is determined to be valid; and
in the determination as to whether the license is valid, in response to a call instruction, determining whether or not a license of a first application program is valid, and permitting the first application program to be executed if the license is determined to be valid, wherein the first application program is installed with the license, uniquely associated with access destination information for calling a specific web application, and accesses an access destination specified in the access destination information.

16. An image forming apparatus comprising:
a web browser; and
an installing unit that, in the case where a license in license information of an application is determined to be valid using the license information, installs the application,
wherein a first application that realizes a function in the image forming apparatus and a second application that realizes a function of a web app in a web server by calling the web browser are installed using the installing unit.

17. The image forming apparatus according to claim 16,
wherein the installing unit installs the second application corresponding to the web app on a web app-by-web app basis.

18. The image forming apparatus according to claim 17, further comprising:
a sending unit that, upon the second application being instructed to be called, sends an electronic signature using an encryption key included in the second application and a request to access a URL included in the second application.

19. The image forming apparatus according to claim 18,
wherein the encryption key differs for each web app.
